(19) United States
(12) Patent Application Publication
(10) Pub. No.: US 2025/0257782 A1
(43) Pub. Date: Aug. 14, 2025

(54) DAMPING VALVE DEVICE FOR A SHOCK ABSORBER OF A MOTOR VEHICLE

(71) Applicants: thyssenkrupp Bilstein GmbH, Ennepetal (DE); thyssenkrupp AG, Essen (DE)

(72) Inventor: Klaus SCHMIDT, Odenthal (DE)

(73) Assignees: thyssenkrupp Bilstein GmbH, Ennepetal (DE); thyssenkrupp AG, Essen (DE)

(21) Appl. No.: 19/051,379

(22) Filed: Feb. 12, 2025

(30) Foreign Application Priority Data
Feb. 13, 2024 (DE) 10 2024 103 965.5

(51) Int. Cl. F16F 9/346; F16F 9/18

(52) U.S. Cl. CPC F16F 9/346; F16F 9/185

(57) ABSTRACT

A vibration damper for a motor vehicle comprises an outer tube and an inner tube arranged coaxially thereto, a working piston which is arranged axially movably inside the inner tube and divides the interior of the inner tube into a working chamber on the piston rod side and a working chamber remote from the piston rod, a first damping valve device with a first inlet connector for inlet of hydraulic fluid into the first damping valve device, and a second damping valve device with a second inlet connector for inlet of hydraulic fluid into the second damping valve device, wherein the first inlet connector extends radially inwardly through a first middle tube opening and an inner tube opening into the working chamber remote from the piston rod.

### CROSS REFERENCE TO RELATED APPLICATION

This application is a U.S. Non-Provisional that claims priority to German Patent Application No. DE 10 2024 103 965.5, filed Feb. 13, 2024, the entire content of which is incorporated herein by reference.

### FIELD

The present disclosure relates to a damping valve device for a shock absorber for motor vehicles, wherein the damping valve device has a main valve and a pilot valve.

### BACKGROUND

DE102021202418A1 discloses a vibration damper which has two external damping valves. Differing requirements for the installation space of the vibration damper in the vehicle require maximum flexibility and compactness of the arrangement of the damping valves relative to one another.

Thus a need exists to provide a vibration damper having two external damping valves which have a high degree of freedom in their arrangement relative to one another.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic illustration of a vibration damper according to a first exemplary embodiment, in a longitudinal sectional view.

FIG. 2 shows a schematic illustration of a detail view of a damping valve device according to an exemplary embodiment, in a longitudinal sectional illustration.

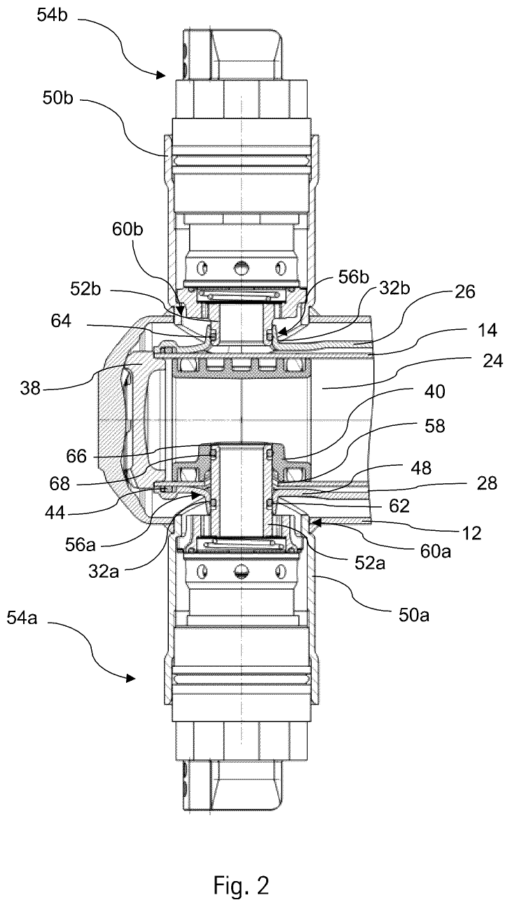

FIGS. 3 and 4 each show a schematic illustration of a detail view of a damping valve device according to further exemplary embodiments, in a plan view.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

According to a first aspect, a vibration damper for a motor vehicle comprises an outer tube and an inner tube arranged coaxially thereto, and a working piston which is arranged axially movably inside the inner tube and divides the interior of the inner tube into a working chamber on the piston rod side and a working chamber remote from the piston rod. The vibration damper has a first damping valve device with a first inlet connector for inlet of hydraulic fluid into the first damping valve device, and a second damping valve device with a second inlet connector for inlet of hydraulic fluid into the second damping valve device. The first inlet connector extends radially inwardly through a first middle tube opening and an inner tube opening into the working chamber remote from the piston rod.

Such an arrangement offers a particularly space-saving valve mounting, wherein the damping valve devices can be oriented in different positions, in particular at different angles and axial positions.

The vibration damper is for example a single-tube vibration damper or a multi-tube vibration damper, for example a twin-tube vibration damper. The vibration damper comprises for example an outer tube which forms an outer face, in particular a housing, of the vibration damper. An inner tube, also known as a damper tube, is arranged inside the outer tube and coaxially thereto. A balance chamber, which is preferably filled at least partially with a hydraulic fluid, is formed between the outer tube and the inner tube. For example, the balance chamber is partially filled with a gas.

Preferably, a working piston connected to a piston rod is arranged inside the inner tube such that it is movable inside the inner tube, wherein the inner tube is preferably formed as a guide for the working piston. A valve device for example is arranged on the working piston. The working piston divides the interior of the inner tube in particular into a first working chamber on the piston rod side and a second working chamber remote from the piston rod.

The damping valve devices are for example arranged at least partially outside the outer tube of the vibration damper. Inside the balance chamber, preferably a middle tube is arranged coaxially to and between the inner tube and the outer tube. The damping valve devices are for example mounted on the middle tube. The middle tube is preferably mounted fluid-tightly on the inner tube, wherein an annular chamber is formed between the middle tube and the inner tube. The damping valve devices are preferably configured identically.

The middle tube is preferably attached to the inner tube by means of two middle tube mountings. The first middle tube mounting is for example arranged at the end of the middle tube remote from the piston rod, and the second middle tube mounting is arranged at the end of the middle tube on the piston rod side. The middle tube mounting preferably comprises two constrictions running circumferentially, radially on the inside, wherein in the region of the constrictions, the diameter of the middle tube is reduced such that the middle tube rests on the inner tube, preferably by means of a play fit. An in particular annular widening of the middle tube adjoins the constriction, wherein in the region of the widening, the diameter of the middle tube is widened to the previous diameter outside the constriction. Adjoining the widening on the outside in the axial direction is a further constriction for example, which in particular forms the end of the middle tube. The widening is preferably configured such that it forms a closed annular chamber between the middle tube and the inner tube. A sealing element, in particular a sealing ring, is for example arranged inside the annular chamber, resting on the inner tube and on the middle tube and forming a fluid-tight seal between them. The middle tube optionally extends over the entire length of the inner tube. In particular, the middle tube has a length which corresponds for example to 50% to 110%, in particular 90% to 100% of the length of the inner tube.

In particular, an annular chamber is formed between the middle tube and the inner tube. At least one passage opening is formed in the inner tube, fluidically connecting the first working chamber to the annular chamber. The passage opening preferably opens into the end of the annular chamber on the piston rod side. The middle tube is for example made from a metal.

The vibration damper preferably comprises at least two damping valve devices arranged at least partially outside the outer tube. The first damping valve device is preferably configured and arranged such that hydraulic fluid flows through it, in the compression stage, upon a movement of the working piston in the compression direction. The second damping valve device is preferably configured and arranged such that hydraulic fluid flows through it, in the extension stage, upon a movement of the working piston in the extension direction.

Preferably, the first damping valve device is designated the compression stage valve and in particular is configured such that it damps the movement of the working piston in the compression direction. Preferably, the second damping valve device is designated the extension stage valve and in particular is configured such that it damps the movement of the working piston in the extension direction. The damping valve devices are for example magnetic control valves, pressure-limiting valves or multiway valves which preferably allow flow exclusively in one direction.

The middle tube in particular has a first middle tube opening which is configured and arranged for receiving the first damping valve device. The middle tube opening has in particular a circular cross section.

The inner tube preferably has an inner tube opening which is configured and arranged for receiving the first damping valve device, in particular the compression stage valve. The inner tube opening is in particular formed to be circular and preferably arranged coaxially to the first middle tube opening. The inner tube preferably has precisely one inner tube opening for receiving a damping valve device.

The outer tube preferably has a first and a second outer tube opening which are configured and arranged for receiving a respective damping valve device. The outer tube opening is in particular formed to be circular and preferably arranged coaxially to the respective middle tube opening. The outer tube preferably has precisely two outer tube openings for receiving a respective damping valve device.

The damping valve device preferably has a valve housing which forms the outer face of the damping valve device. The valve housing is arranged at least partially outside the outer tube and in particular is fixedly connected to the outer tube. The valve housing is preferably formed to be tubular. Coaxially to the valve housing, the damping valve device has an inlet connector which is preferably formed to be tubular and forms a fluid inlet into the respective damping valve device. The first inlet connector preferably forms a fluid inlet into the first damping valve device, wherein the second inlet connector preferably forms a fluid inlet into the second damping valve device. The first inlet connector of the first damping valve device preferably extends in the radial direction into the working chamber remote from the piston rod. For example, the first inlet connector extends through the first outer tube opening, the first middle tube opening and the inner tube opening, and opens into the working chamber remote from the piston rod. The second inlet connector extends in particular through the second outer tube opening and the second middle tube opening, and opens into the annular chamber between the middle tube and the inner tube.

The first damping valve device is preferably fluidically connected directly to the working chamber remote from the piston rod and to the balance chamber, wherein the second damping valve device is in particular fluidically connected directly to the annular chamber and to the balance chamber. The damping valve device comprises a preferably cylindrical damping valve housing.

The vibration damper preferably has a closure package which fluidically seals the interior of the outer tube on the piston rod side. Opposite the closure package, at the end remote from the piston rod, the interior of the outer tube is preferably fluidically sealed by means of a bottom piece.

Optionally, a bottom valve is arranged on the bottom piece, mounted at the end of the inner tube remote from the piston rod.

According to a first embodiment, the middle tube has the first middle tube opening and a second middle tube opening. The middle tube has in particular precisely two or more middle tube openings, which are configured and arranged for receiving a respective damping valve device. The middle tube openings in particular have a circular cross section. Preferably, the middle tube openings, in particular the middle points of the middle tube openings, are arranged in a common plane which is arranged perpendicularly to the central axis of the outer tube. The middle tube openings are preferably aligned with one another, in particular arranged coaxially to one another, and preferably have an identical diameter and an identical geometry.

According to a further embodiment, the second inlet connector extends through the second middle tube opening. The first middle tube opening is preferably configured and arranged for receiving the first damping valve device, and the second middle tube opening is preferably configured and arranged for receiving the second damping valve device. In particular, the second inlet connector does not extend through the inner tube.

According to a further embodiment, the second inlet connector opens into an annular chamber between the inner tube and the middle tube. The second inlet connector is preferably directly fluidically connected to the annular chamber and to the balance chamber. Preferably, the valve outlet is arranged in a region between the valve housing and the inlet connector. The valve outlet of the damping valve devices in particular fluidically directly adjoins the balance chamber.

According to a further embodiment, the damping valve devices are arranged in a common plane which extends perpendicularly to the central longitudinal axis of the vibration damper, in particular of the outer tube. The damping valve devices are for example mounted at the same axial height of the outer tube. For example, the damping valve devices are arranged coaxially to one another. In particular, each damping valve device is arranged in a respective plane which extends perpendicularly to the central longitudinal axis of the vibration damper, in particular of the outer tube. Preferably, the planes are arranged axially offset to one another.

According to a further embodiment, the damping valve devices are arranged in a common axial portion of the outer tube. The axial portion is for example the end region of the outer tube remote from the piston rod. Preferably, the axial portion extends from the bottom of the outer tube over around 10% to 25% of the length of the outer tube.

According to a further embodiment, the central axes of the damping valve devices, in the circumferential direction of the outer tube, form an angle of 20° to 180°, in particular 60° to 135°, preferably 90° to 120° to one another.

According to a further embodiment, the middle tube extends as far as the end of the inner tube remote from the piston rod. Preferably, the middle tube terminates flush with the inner tube at the end remote from the piston rod.

According to a further embodiment, the vibration damper has a bottom piece which forms the end remote from the piston rod of the working chamber remote from the piston rod, wherein the middle tube extends in the axial direction as far as the bottom piece. Preferably, the middle tube rests on the bottom piece. The bottom piece is preferably fluid-tightly connected to the inner tube and/or the outer tube. Preferably, the bottom piece is formed to be pot-shaped.

According to a further embodiment, the vibration damper has an adapter for the mounting of the first damping valve device, wherein the adapter has an adapter opening through which the first inlet connector extends. The adapter is preferably formed to be tubular and arranged coaxially to the outer tube. The adapter is in particular arranged completely inside the inner tube, and preferably rests with its radial outer face on the inner face of the inner tube. In particular, the adapter is fluid-tightly connected to the inner tube. The adapter has an adapter opening which is configured and arranged for receiving the first damping valve device, in particular the first inlet connector. The first inlet connector extends for example through the adapter opening and terminates preferably flush therewith. The adapter is preferably fluid-tightly connected to the first inlet connector. In particular, a sealing means, such as for example a sealing ring, is arranged between the adapter and the first inlet connector. The sealing means is arranged for example in a circumferential recess in the first inlet connector. The vibration damper preferably has precisely one adapter.

According to a further embodiment, the middle tube has a first flange region for the mounting of the first damping valve device and a second flange region for the mounting of the second damping valve device, wherein the first flange region is fluid-tightly connected to the first inlet connector and the second flange region is fluid-tightly connected to the second inlet connector.

Preferably, the middle tube has precisely two or more flange regions which each form one of the middle tube openings. Each flange region preferably forms a respective receiver for one of the damping valve devices. The flange regions are preferably formed identically. The flange region preferably circumferentially surrounds the middle tube opening.

In particular, the flange region has a radially outwardly pointing collar which delimits the preferably circular middle tube opening. The collar is preferably formed to be tubular and extends in particular coaxially to the respective damping valve device. A radial constriction radially adjoins the collar on the inside, forming a narrowing of the diameter of the middle tube. The narrowing of the diameter causes a reduction in the width of the annular chamber between the inner tube and the middle tube, and preferably forms a flow restrictor.

The first flange region is preferably fluid-tightly connected to the first inlet connector. For example, a sealing element, such as for example a sealing ring, is mounted between the first inlet connector and the first flange region. The sealing element is preferably arranged in a circumferential recess in the first inlet connector. The second flange region is in particular fluid-tightly connected to the second inlet connector. A further sealing element, such as for example a sealing ring, is mounted between the second inlet connector and the second flange region. The sealing element is preferably arranged in a circumferential recess in the second inlet connector.

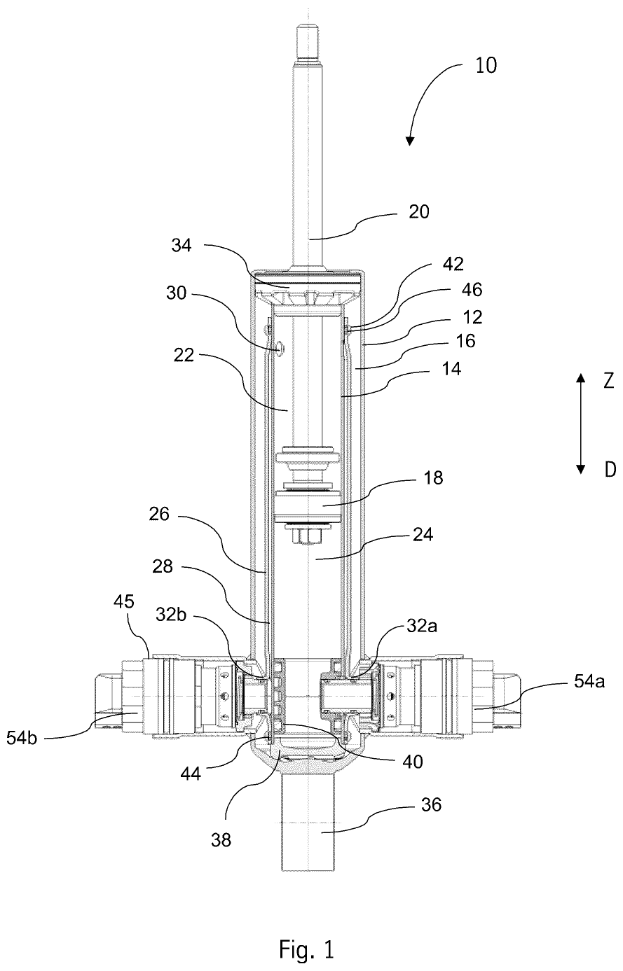

FIG. 1 shows a vibration damper 10, wherein the vibration damper 10 is a multi-tube vibration damper, for example a twin-tube vibration damper. The vibration damper 10 has an outer tube 12 which forms an outer face, in particular a housing, of the vibration damper 10. An inner tube 14, which may also be designated a damper tube, is arranged inside the outer tube 12 and coaxially thereto. A balance chamber 16, which is preferably at least partially filled with a hydraulic fluid, is formed between the outer tube 12 and the inner tube 14, in particular between the outer tube 12 and the middle tube 26. For example, the balance chamber 16 is partially filled with a gas.

A working piston 18, connected to a piston rod 20, is arranged inside the inner tube 14 so as to be movable inside the inner tube 14, wherein the inner tube 14 is preferably configured as a guide for the working piston 18. The working piston 18 has for example a valve device (not shown). The working piston 18 divides the interior of the inner tube 14 into a first working chamber 22 which is arranged on the piston rod side, and a second working chamber 24 which is arranged on the side remote from the piston rod. Inside the balance chamber 16, a middle tube 26 is arranged coaxially to and between the inner tube 14 and the outer tube 12.

The interior of the outer tube 12 is fluidically sealed on the piston rod side by means of a closure package 34. Opposite the closure package 34, at the end remote from the piston rod, the interior of the outer tube 12 is fluidically sealed by means of a bottom piece 38. Optionally, a bottom valve is arranged on the bottom piece 38, mounted in particular on the end of the inner tube 14 remote from the piston rod. The bottom valve is for example a check valve which allows flow in both directions or in only one direction. The second working chamber 24 is preferably fluidically connected to the balance chamber 16 via the bottom valve. The end of the inner tube 14 and outer tube 12 on the piston rod side is preferably attached to the closure package 34. A body connection 36, for example, by means of which the vibration damper 10 can be attached to the vehicle body, in particular the vehicle axle, adjoins the bottom piece.

The middle tube 26 is preferably fluid-tightly mounted on the inner tube 14. For example, the middle tube 26 is mounted on the inner tube 14 by means of two middle tube mountings 42, 44. The middle tube 26 preferably extends over the entire length of the inner tube 14; in particular, the middle tube 26 has a length which corresponds to around 90% to 100% of the length of the inner tube 14. The first middle tube mounting 44 is arranged at the end of the middle tube 26 remote from the piston rod, and the second middle tube mounting 42 is arranged at the end of the middle tube 26 on the piston rod side. The middle tube mounting 42, 44 preferably comprises two constrictions running circumferentially, radially on the inside, wherein in the region of the constrictions, the diameter of the middle tube 26 is reduced such that the middle tube 26 rests, preferably fluid-tightly, on the inner tube 14. Adjoining the constriction is an in particular annular widening of the middle tube 26, wherein in the region of the widening, the diameter of the middle tube 26 is increased to the previous diameter outside the constriction. A further constriction adjoins the widening on the outside in the axial direction, forming for example the end of the middle tube 26. With the exception of the middle tube mounting 42, 44, the middle tube 26 preferably has a constant diameter and cross section. The widening is preferably formed such that it forms a closed annular chamber between the middle tube 26 and the inner tube 14. A sealing element 46, in particular a sealing ring, is for example arranged inside the annular chamber, resting on the inner tube 14 and the middle tube 26 and forming a fluid-tight seal between them. Preferably, the middle tube mounting 42, 44 has a respective annular chamber with a sealing element 46. The middle tube 26 preferably extends as far as the end of the inner tube 14 remote from the piston rod and for example terminates flush therewith. For example, the middle tube 26 extends axially as far as the bottom piece 38 and preferably rests thereon.

An annular chamber 28 is formed between the middle tube 26 and the inner tube 14. At least one passage opening 30, which fluidically connects the first working chamber 22 to the annular chamber 28, is formed in the inner tube 14. The passage opening 30 is formed in the first working chamber 22, in particular at the end of the inner tube 14 on the piston rod side. Preferably, the passage opening 30 is arranged directly below the second middle tube mounting 42. The passage opening 30 preferably opens into the end of the annular chamber 28 on the piston rod side. The middle tube 26 is preferably made of a metal.

The vibration damper 10 preferably comprises two damping valve devices 54a,b, wherein hydraulic fluid flows through a respective damping valve device 54a, in the compression stage, upon a movement of the working piston 18 in the compression direction D, and through the respective other damping valve device 54b, in the extension stage, upon a movement of the working piston 18 in the extension direction Z. Preferably, the first damping valve device 54a is designated the compression stage valve, and in particular is configured such that it damps the movement of the working piston 18 in the compression direction D. In particular, the compression stage valve 54a is configured and arranged such that hydraulic fluid flows through it exclusively upon a movement of the working piston 18 in the compression direction D. Preferably, the second damping valve device 54b is designated the extension stage valve, and in particular is configured such that it damps the movement of the working piston 18 in the extension direction Z. In particular, the extension stage valve 54b is configured and arranged such that hydraulic fluid flows through it exclusively upon a movement of the working piston 18 in the extension direction Z.

The damping valve devices 54a,b are for example formed substantially identically. The damping valve devices 54a,b are for example magnetic control valves, pressure-limiting valve or multiway valves which allow flow exclusively in one direction. The damping valve devices 54a,b are for example mounted at the same axial height of the outer tube 12. It is also conceivable that the damping valve devices 54a,b are mounted at different axial heights. Preferably, the damping valve devices 54a,b are arranged in a common plane which extends perpendicularly to the central longitudinal axis of the vibration damper 10, in particular of the outer tube 12. In particular, the damping valve devices 54a,b are arranged in a common axial portion of the outer tube 12, wherein the axial portion is the end region of the outer tube 12 remote from the piston rod. Preferably, the axial portion extends from the bottom of the outer tube 12 over around 10% to 25% of the length of the outer tube 12. Optionally, the damping valve devices 54a,b are arranged coaxially to one another.

The middle tube 26 has in particular two middle tube openings 56a,b which are configured and arranged for receiving a respective damping valve device 54a,b. The first middle tube opening 56a is preferably configured and arranged for receiving the first damping valve device 54a, and the second middle tube opening 56b is preferably configured and arranged for receiving the second damping valve device 54b. The middle tube openings 56a,b in particular have a circular cross section.

Preferably, the middle tube 26 has precisely two or more flange regions 32a,b which form the middle tube openings 56a,b. Each flange region 32a preferably forms a respective receiver for one of the damping valve devices 54a,b. The middle tube 26 for example has a first flange region 32a for mounting the first damping valve device 54a, in particular the compression stage valve, and a second flange region 32b for mounting the second damping valve device 54b, in particular the extension stage valve. The flange regions 32a,b are preferably formed identically. The flange region 32a,b preferably forms the middle tube opening 56a,b and preferably circumferentially surrounds the middle tube opening 56a,b.

In particular, the flange region 32a,b has a radially outwardly pointing collar which delimits the preferably circular middle tube opening 56a,b. The collar is for example formed to be tubular and preferably extends coaxially to the respective damping valve device 54a,b. Adjoining the collar radially on the inside is a radial constriction 48, which forms a narrowing of the diameter of the middle tube 26. The narrowing of the diameter causes a reduction in the width of the annular chamber 28 between the inner tube 14 and the middle tube 26, and preferably forms a flow restrictor.

The inner tube 14 preferably has an inner tube opening 58 which is configured and arranged for receiving a damping valve device 54a, in particular the compression stage valve 54a. The inner tube opening 58 is in particular formed to be circular and preferably arranged coaxially to the first middle tube opening 56a. The inner tube 14 preferably has precisely one inner tube opening 58 for receiving a damping valve device 54a.

The outer tube 12 preferably has a first and a second outer tube opening 60a,b, which are configured and arranged for receiving a respective damping valve device 54a,b. The outer tube opening 60a,b is in particular formed to be circular and is preferably arranged coaxially to the respective middle tube opening 56a,b. The outer tube 12 has preferably precisely two outer tube openings 60a,b for receiving a respective damping valve device 54a,b.

The damping valve device 54a,b has for example a valve housing 50a,b which forms the outer face of the damping valve device 54a,b. The valve housing 50a,b is arranged outside the outer tube 12. The valve housing 50a,b is preferably formed to be tubular and for example has a plurality of different diameters. Coaxially to the valve housing 50a,b, the damping valve device 54a,b has an inlet connector 52a,b which for example is formed to be tubular and forms a fluid inlet into the respective damping valve device 54a,b. The first inlet connector 52a preferably forms a fluid inlet into the first damping valve device 54a, and the second inlet connector 52b preferably forms a fluid inlet into the second damping valve device 54b. The first inlet connector 52a of the first damping valve device 54a preferably extends in the radial direction into the working chamber remote from the piston rod. For example, the first inlet connector 52a extends through the first outer tube opening 60a, the first middle tube opening 56a and the inner tube opening 58, and opens into the working chamber 24 remote from the piston rod. The second inlet connector 52b extends in particular through the second outer tube opening 60b and the second middle tube opening 56b, and opens into the annular chamber 28.

The first damping valve device 54a is preferably fluidically connected to the working chamber 24 remote from the piston rod and to the balance chamber 16, wherein the second damping valve device 54b is fluidically connected to the annular chamber 28 and to the balance chamber 16.

The first flange region 32a is preferably fluid-tightly connected to the first inlet connector 52a. For example, a sealing element 62, such as for example a sealing ring, is mounted between the first inlet connector 52a and the first flange region 32a. The sealing element 62 is preferably arranged in a circumferential recess in the first inlet connector 52a. The second flange region 32b is in particular fluid-tightly connected to the second inlet connector 52b. A further sealing element 64, such as for example a sealing ring, is mounted between the second inlet connector 52b and the second flange region 32b. The sealing element 64 is preferably arranged in a circumferential recess in the second inlet connector 52b.

The vibration damper 10 comprises for example an adapter 40 for the mounting of the first damping valve device 54a, in particular the compression stage valve. The adapter 40 is for example formed to be tubular and arranged coaxially to the outer tube 12. The adapter 40 is arranged inside the inner tube 14 and preferably rests with its radially outer face on the inner face of the inner tube 14. In particular, the adapter 40 is fluid-tightly connected to the inner tube 14. The adapter 40 has an adapter opening 66 which is configured and arranged for receiving the first damping valve device 54a, in particular the first inlet connector 52a. The first inlet connector 52a extends for example through the adapter opening 66 and terminates preferably flush therewith. The adapter 40 is preferably fluid-tightly connected to the first inlet connector 52a. In particular, a sealing means 68, for example a sealing ring, is arranged between the adapter 40 and the first inlet connector 52a. The sealing means 68 is arranged for example in a circumferential recess in the first inlet connector 52a.

The piston rod 20 has for example an optional extension stop which is loaded with a spring force via a spring element 42 upon a movement in the extension direction Z.

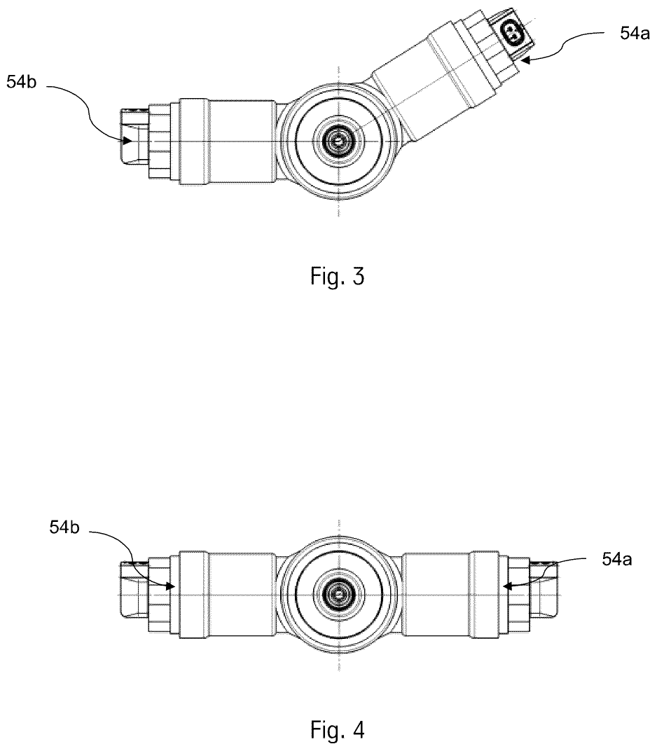

FIG. 3 and FIG. 4 show further possible arrangements of the damping valve devices 54a,b relative to one another. In the exemplary embodiment of FIG. 3, the first and the second damping valve devices 54a,b are arranged for example in a common plane, wherein the central axes of the damping valve devices 54a,b extend perpendicularly to the central axis of the outer tube 12. The central axes of the damping valve devices 54a,b form for example an angle of 135° to one another. In the exemplary embodiment of FIG. 4, the damping valve devices 54a,b are arranged coaxially to one another and form for example an angle of 180° to one another. For example, the central axes of the damping valve devices 54a,b form an angle of 20° to 180°, in particular 60° to 135°, for example 90° to 120° to one another.

### LIST OF REFERENCE SIGNS

10 Vibration damper
12 Outer tube
14 Inner tube
16 Balance chamber
18 Working piston
20 Piston rod
22 First working chamber/working chamber on piston rod side
24 Second working chamber/working chamber remote from piston rod
26 Middle tube
28 Annular chamber
30 Passage opening
32a First flange region
32b Second flange region
34 Closure package
36 Body connection
38 Bottom piece
40 Adapter
42 Second middle tube mounting
44 First middle tube mounting
46 Sealing element
48 Constriction
50a Valve housing of first damping valve device
50b Valve housing of second damping valve device
52a First inlet connector
52b Second inlet connector
54a First damping valve device/compression stage valve
54b Second damping valve device/extension stage valve
56a First middle tube opening
56b Second middle tube opening
58 Inner tube opening
60a First outer tube opening
60b Second outer tube opening
62 Sealing element
64 Sealing element
66 Adapter opening
68 Sealing means

1. A vibration damper for a motor vehicle, comprising:
an outer tube and an inner tube arranged coaxially thereto;
a working piston which is arranged axially movably inside the inner tube and divides the interior of the inner tube into a working chamber on the piston rod side and a working chamber remote from the piston rod;
a first damping valve device with a first inlet connector for inlet of hydraulic fluid into the first damping valve device; and
a second damping valve device with a second inlet connector for inlet of hydraulic fluid into the second damping valve device;
wherein the first inlet connector extends radially inwardly through a first middle tube opening and an inner tube opening into the working chamber remote from the piston rod.

2. The vibration damper according to claim 1, wherein the middle tube has the first middle tube opening and a second middle tube opening.

3. The vibration damper according to claim 2, wherein the second inlet connector extends through the second middle tube opening.

4. The vibration damper according to claim 1, wherein the second inlet connector opens into an annular chamber between the inner tube and the middle tube.

5. The vibration damper according to claim 1, wherein the damping valve devices are arranged in a common plane which extends perpendicularly to the central longitudinal axis of the outer tube.

6. The vibration damper according to claim 1, wherein the central axes of the damping valve devices, in the circumferential direction of the outer tube, form an angle of 20° to 180° to one another.

7. The vibration damper according to claim 1, wherein the central axes of the damping valve devices, in the circumferential direction of the outer tube, form an angle of 60° to 135° to one another.

8. The vibration damper according to claim 1, wherein the central axes of the damping valve devices, in the circumferential direction of the outer tube, form an angle of 90° to 120° to one another.

9. The vibration damper according to claim 1, wherein the middle tube extends as far as the end of the inner tube remote from the piston rod.

10. The vibration damper according to claim 1, wherein the vibration damper has a bottom piece which forms the end remote from the piston rod of the working chamber remote from the piston rod, and wherein the middle tube extends in the axial direction as far as the bottom piece.

11. The vibration damper according to claim 1, wherein the vibration damper has an adapter for the mounting of the first damping valve device, and wherein the adapter has an adapter opening through which the first inlet connector extends.

12. The vibration damper according to claim 1, wherein the middle tube has a first flange region for the mounting of the first damping valve device and a second flange region for the mounting of the second damping valve device, and wherein the first flange region is fluid-tightly connected to the first inlet connector and the second flange region is fluid-tightly connected to the second inlet connector.

13. The vibration damper according to claim 1, wherein the damping valve devices are mounted in the same axial region of the outer tube.
